(19) United States
(12) Patent Application Publication
(10) Pub. No.: US 2004/0041481 A1
(43) Pub. Date: Mar. 4, 2004

(54) Magnetism driven power machine

(76) Inventor: Jin-Hu Kuo, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/227,829

(22) Filed: Aug. 27, 2002

(51) Int. Cl. H02K 21/00

(52) U.S. Cl. 310/152

(57) ABSTRACT

A magnetism driven power machine includes a main body, a rotating rack, rotors, and stators. The main body is cylindrical. The rotating rack can rotate about a central axis of the main body, and has two opposing disks connected to the shaft thereof. Each of the rotors has a bent bar connected to inner sides of the disks at two ends. The rotors have magnets spaced along the bent bars. Each of the stators has C-shaped magnets spaced along one of rods positioned along the outer side of the cylindrical wall. Rotation of the rotating rack can continue with attraction and repulsion of the magnets and corresponding C-shaped magnets, allowing the shaft to pass on rotation to other machinery connected thereto. Adjustment member is provided for adjusting distance between the magnets to adjust power output.

### BACKGROUND OF THE INVENTION

1. Field of the Invention

The present invention relates to a power machine, more particularly a power machine, which includes a rotor equipped with magnets, and a stator also equipped with magnets so that rotational movement of the rotor can be produced with the attraction and repulsion of the magnets.

2. Brief Description of the Prior Art

While electricity has been the most common source in powering a motor, which is provided for passing on the rotation of the rotor affected by electricity to other machinery, man is still searching for new and inexpensive sources of producing electricity. Wind power has long been used as one such source. Electricity is provided to a motor so that a magnetic field is formed for effecting rotation of the shaft. It is also a main task to provide increased power output with certain amount of electricity, or certain amount of power output with decreased consumption of electricity for a motor. It is another task to provide a power machine that has power output capable of being adjusted to fit various circumstances. Because magnets have the advantages of having magnetic force that is continual and not prone to decrease, they are taken into consideration in searching for inexpensive substitutes for electricity.

### SUMMARY OF THE INVENTION

It is a main object of the present invention to provide a magnetism driven power machine, which includes a rotor equipped with magnets, and a stator also equipped with magnets so that rotation of the rotor can be effected by means of the attraction and repulsion of the magnets.

It is another object of the present invention to provide a magnetism driven power machine, of which power output can be adjusted to fit various circumstances.

The present magnetism driven power machine includes a main body, a rotating rack, rotors, and stators. The main body is cylindrical. The rotating rack can rotate about the central axis of the main body, and has two opposing disks connected to the shaft thereof. Each of the rotors has a bent bar connected to inner sides of the disks at two ends, and has magnets spaced along the bent bar. Each of the stators has C-shaped magnets spaced along respective one of rods equidistantly positioned along the outer side of the cylindrical wall. Thus, attraction and repulsion of the magnets and corresponding C-shaped magnets make rotation of the rotating rack continue. Adjustment member is provided for displacing the C-shaped magnets relative to corresponding magnets to adjust power output of the present machine.

### BRIEF DESCRIPTION OF THE DRAWINGS

The present invention will be better understood by reference to the accompanying drawings, wherein:

FIG. 1 is a perspective view of the interior of the magnetism driven power machine according to the present invention,

FIG. 2 is a cross-sectional view of the magnetism driven power machine according to the present invention,

FIG. 3 is another cross-sectional view of the magnetism driven power machine according to the present invention,

FIG. 4 is a cross-sectional view of the adjustment member for the magnetism driven power machine according to the present invention,

FIG. 5 a partial cross-sectional view of the magnetism driven power machine according to the present invention,

FIG. 6 is a view showing the use of the adjustment member according to the present invention; and,

FIG. 7 is a view showing the adjustment member of the present power machine under operation.

### DETAILED DESCRIPTION OF THE PREFERRED EMBODIMENTS

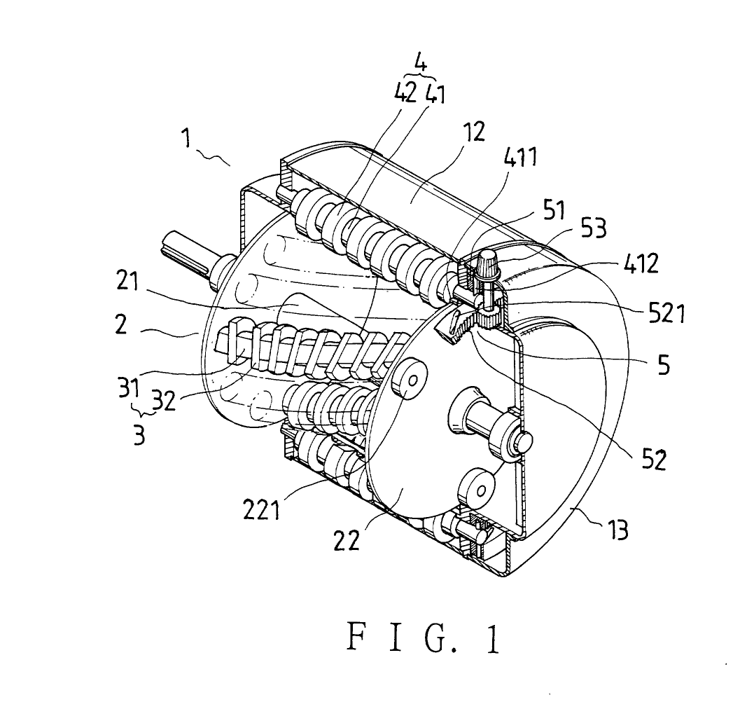

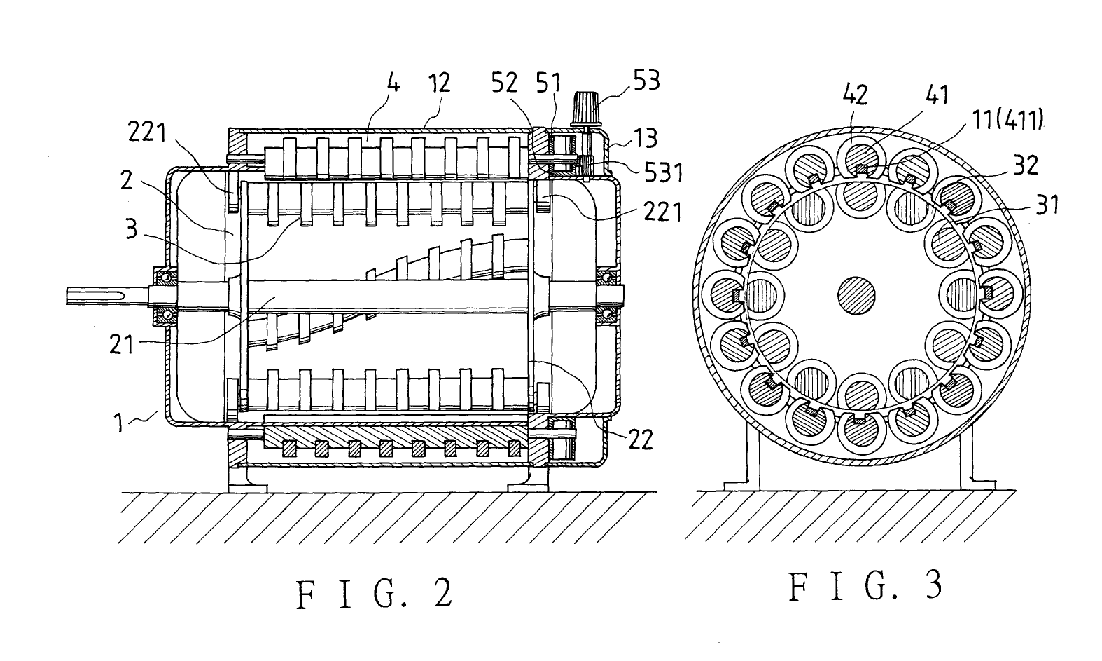

Referring to FIGS. 1, 2 and 3, a magnetism driven power machine of the present invention includes a main body 1, a rotating rack 2, a rotor set 3, a stator set 4, and an adjustment member 5.

The main body 1 has a cylindrical outer wall, and end covers 13 fitted to two ends of the cylindrical wall. Straight guiding protrusions 11 are equidistantly formed along an outer side of the cylindrical wall of the main body 1 to be parallel with the axis of the main body 1.

The rotating rack 2 has a shaft 21, and two disk-shaped portions 22. The shaft 21 is positioned along the central axis of the main body 1 with two ends thereof sticking out from the end covers 13 of the main body 1 so that the rotating rack 2 can be turned in the main body 1. The disk-shaped portions 22 are connected to the shaft 21 at centers thereof In addition, the disk-shaped portions 22 have wheels 221 fitted to outward sides thereof to come into contact with an inner side of the cylindrical wall of the main body 1.

The rotor set 3 includes several rotor elements, each of which has a connecting bar 31, and several magnets 32 equidistantly spaced along the connecting bars 31. The connecting bars 31 are turned around a central point and bent to a certain shape, and are connected to inner sides of the disk-shaped portions 22 at a first end and a second end; the first ends and the second ends of the bars 31 are preferably spaced around the centers of the corresponding disk-shaped portions 22. The magnets 32 are arranged such that flat sides thereof face outwards, and lines normal to the flat sides form a radial pattern.

The stator set 4 includes several stator elements, each of which has a guiding rod 41, and several C-shaped magnets 42 equidistantly spaced along the guiding rods 41. Each of the guiding rods 41 has a guiding trench 411 lengthwise formed thereon. The guiding rods 41 are movably fitted on the cylindrical wall of the main body 1 with the guiding trenches 411 being fitted onto a respective one of the straight guiding protrusions 11 of the main body 1. The C-shaped magnets 42 are arranged such that openings thereof face the outer side of the cylindrical wall of the main body 1. The guiding rods 41 further stick through an inner section of a first one of the end covers 13 of the main body 1 at a first end for connection with the adjustment member 5. And, each of the first ends of the guiding rods 41 is equipped with a pin 412 that is positioned perpendicular thereto. A housing member 12 is joined to the main body 1 to protect the stator set 4.

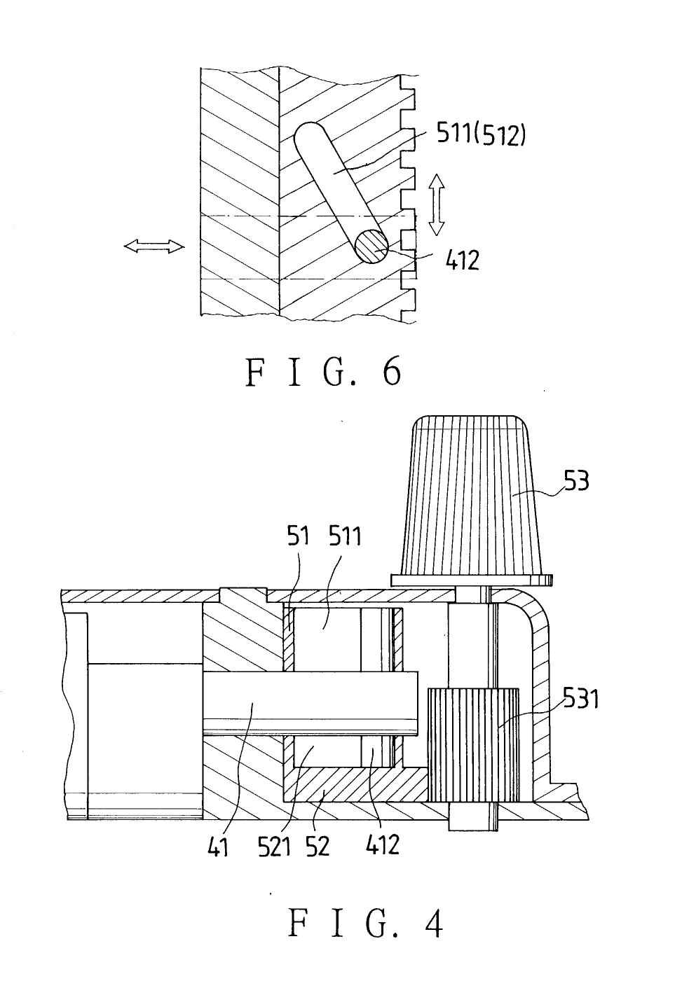

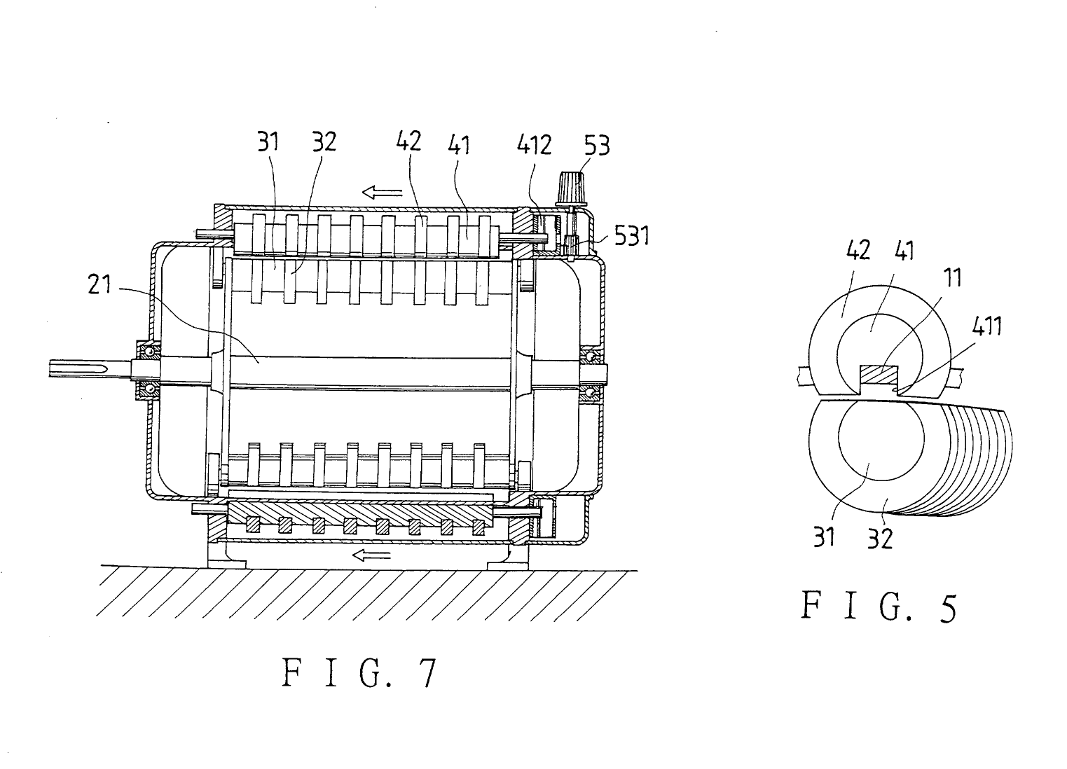

Referring to FIGS. 4, 5 and 6, the adjustment member 5 includes an exterior adjusting ring 51, an interior adjusting ring 52, an adjustment knob 53, and a gear wheel 531. The adjustment knob 53 is fitted to the first end cover 13, and joined to the gear wheel 531, which is disposed in an annular compartment of the first end cover 13. The exterior adjusting ring 51, and the interior adjusting ring 52 are positioned in the annular compartment of the first end cover 13. The interior adjusting ring 52 has a toothed side (not numbered) engaging the gear wheel 531. The adjusting rings 51, 52 have opposing guiding slots 511, 512 spaced thereon; the guiding slots 511, 52 being arranged to form an acute angle with lateral sides of the rings 511, 521. Furthermore, each of the pins 412 of the guiding rods 41 are inserted into a corresponding one of the guiding slots 511 as well as a corresponding one of the guiding slots 512. Thus, the C-shaped magnets 42 can be displaced in relation to corresponding magnets 32 of the rotor set 3, i.e. the distance from the C-shaped magnets 42 to the corresponding magnets 32 can be adjusted, by means of turning the adjusting knob 53; the slots 521 of the interior ring 52 cause the guiding rods 41 to move along the straight guiding protrusions 11 together with the pins 412 when the adjustment knob 53 is operated.

In using the present power machine, the rotating rack 2 is rotated so that each of the C-shaped magnets 42 of the stator set 4 can attract a corresponding one of the magnets 32 of the stator element moving close thereto, and repel the corresponding one of the magnets 32 of the stator element just moving past it, causing the rotating rack 2 to continue the rotation. Because the connecting bars 31, which the magnets 32 are fitted along, are turned about central points thereof to have curved shape, the magnets 32 of each stator element of the stator set 3 move close to, and away from, the corresponding C-shaped magnets 42 of the stator elements of the stator set 4 in sequence instead of all at the same time, allowing attraction and repulsion of the magnets 42, 32 to persist. Therefore, the shaft 21 can rotate together with the rotating rack 2 with uniform power. The rotational movement is passed onto other machinery connected the shaft 21 such as a generator.

The attraction and repulsion of the magnets will be the biggest if the adjustment member 5 is controlled such that the C-shaped magnets 42 exactly face the corresponding magnet 32 when the magnets 32 are moving over the C-shaped magnets 42, allowing the present power machine to have biggest power output. The attraction and repulsion of the magnets will be smaller than the above biggest one if the adjustment member 5 is controlled such that the C-shaped magnets 42 face the corresponding magnet 32 in an overlapping manner when the magnets 32 are moving over the C-shaped magnets 42. The attraction and repulsion of the magnets will be zero if the adjustment member 5 is controlled such that the C-shaped magnets 42 are positioned between two of the magnet 32 when the magnets 32 are moving over the stator element, not able to effect rotation of the shaft 21.

From the above description, it can be easily understood that the magnetism driven power machine of the present invention has advantages as followings:

1. The power machine can provide continual power with attraction and repulsion of magnets thereof and without consumption of electricity, therefore it is relatively inexpensive as a device for providing power.

2. The power output of the present machine can be adjusted with the adjustment member to fit various circumstances.

What is claimed is:

1. A magnetism driven power machine, comprising
a main body having a cylindrical wall;
a rotating rack fitted in the main body; the rotating rack having a shaft positioned along a central axis of the main body with two ends sticking out from the main body for allowing the rotating rack to be turned in the main body; the rotating rack having two opposing disk-shaped portions connected to the shaft at centers thereof,
a rotor set including a plurality of rotors; the rotors each having a bent connecting bar connected to inner sides of the disk-shaped portions at a first end and a second end; the bent connecting bars having a plurality of magnets equidistantly spaced along them; the magnets being arranged to have flat sides facing outwards and having normal lines forming radial pattern;
a stator set including a plurality of stators; the stators each having C-shaped magnets equidistantly spaced along one of straight guiding protrusions equidistantly formed along the outer side of the cylindrical wall of the main body; the C-shaped magnets being arranged to have openings thereof facing the outer side of the cylindrical wall of the main body;
whereby rotational movement of the rotating rack can be made to continue with attraction and repulsion of the magnets and corresponding C-shaped magnets, allowing the shaft to pass on rotational movement to other machinery connected thereto.

2. The magnetism driven power machine as claimed in claim 1, wherein the C-shaped magnets of the stators are spaced along guiding rods, and each of the guiding rods has a guiding trench movably fitted onto a respective one of the straight guiding protrusions formed on the outer side of the cylindrical wall of the main body, and an adjustment member is fitted to the main body; the adjustment member having an adjusting ring having a plurality of guiding slots spaced thereon; the guiding slots being arranged to form acute angle with lateral sides of the ring; the adjustment member having an adjustment knob connected to a gear wheel; the gear wheel being engaged with an annular toothed side of the adjusting ring for allowing the ring to be turned by means of controlling the knob; each of the guiding rods of C-shaped magnets being equipped with a pin perpendicular thereto at one end thereof to be inserted into a respective one of the guiding slots of the adjusting ring;
whereby the C-shaped magnets can be displaced in relation to corresponding magnets of the rotors for adjusting attraction and repulsion of same and the corresponding magnets by means of controlling the adjusting knob, changing power output of the power machine.

3. The magnetism driven power machine as claimed in claim 1, wherein the disk-shaped portions of the rotating rack have wheels fitted thereto to come into contact with an inner side of the cylindrical wall of the main body, capable of turning in rotation of the rotating rack.
